(19) United States
(12) Patent Application Publication
(10) Pub. No.: US 2012/0298647 A1
(43) Pub. Date: Nov. 29, 2012

(54) METHOD FOR RECOVERING TITANIUM-CONTAINING BYPRODUCTS

(75) Inventors: Hans-Juergen Oexl, Konstanz (DE); Gerhard Auer, Krefeld (DE); Horst Guennel, Kempen (DE); Michael Voessing, Bochum (DE); Sascha Dyschy, Duisburg (DE); Norbert Merkle, Krefeld (DE); Martin Offermann, Moers (DE)

(73) Assignee: CRENOX GMBH, Krefeld (DE)

(21) Appl. No.: 13/519,326

(22) PCT Filed: Dec. 27, 2010
(86) PCT No.: PCT/EP2010/070766

§ 371 Date: Jun. 27, 2012

(30) Foreign Application Priority Data
Dec. 28, 2009 (DE) 10 2009 060 821.4

(51) Int. Cl. B23K 35/22

(52) U.S. Cl. 219/146.1

(57) ABSTRACT

A process for producing a coating material for coating welding electrodes and/or for producing a welding powder which can be used in an electric welding, such as in an under-powder welding, a welding powder additive, and/or a flux additive, includes obtaining a titanium-containing by-product or waste product, such as a titanium dioxide-containing material, in at least one of a production step and a production stage during a titanium dioxide production process, such as a titanium dioxide pigment production process. The titanium-containing by-product or waste product is added and/or mixed into a coating material, a welding powder, a welding powder additive, and/or a flux additive so as to obtain a titanium-containing material mixture. The titanium-containing material mixture is processed so as to provide the coating material, the welding powder, the welding powder additive, and/or the flux additive.

### CROSS REFERENCE TO PRIOR APPLICATIONS

This application is a U.S. National Phase application under 35 U.S.C. §371 of International Application No. PCT/EP2010/070766, filed on Dec. 27, 2010 and which claims benefit to German Patent Application No. 10 2009 060 821.4, filed on Dec. 28, 2009. The International Application was published in German on Jul. 7, 2011 as WO 2011/080253 A1 under PCT Article 21(2).

### FIELD

The present invention relates to a process for producing a coating material for coating welding electrodes or for producing a welding powder which can be used in electric welding, in particular under-powder welding, welding powder additive or flux additive.

The present invention further relates to a process for utilizing a titanium-containing by-product or waste product obtained in the preparation of titanium dioxide.

The present invention also relates to the use of a titanium-containing by-product or waste product obtained in the preparation of titanium dioxide and to a welding powder additive, a welding powder, a coating material and a welding electrode.

### BACKGROUND

In the preparation of titanium dioxide, in particular titanium dioxide pigments, titanium-containing by-products which are difficult to use further and are therefore usually considered to be waste product are usually obtained. Although further utilization of these titanium-containing by-products or waste products, for example, as asphalt filler, as landfill covering or as additive in a blast furnace, is known, this type of use of the titanium-containing by-product or waste product is usually uneconomical.

### SUMMARY

An aspect of the present invention is to provide a utilization and a use of a titanium-containing by-product or waste product obtained in the preparation of titanium dioxide in an economically advantageous way.

In an embodiment, the present invention provides a process for producing a coating material for at least one of coating welding electrodes and for producing a welding powder which can be used in at least one of an electric welding, such as in an under-powder welding, a welding powder additive, and a flux additive, which includes obtaining a titanium-containing by-product or waste product, such as a titanium dioxide-containing material, in at least one of a production step and a production stage during a titanium dioxide production process, such as a titanium dioxide pigment production process. The titanium-containing by-product or waste product is at least one of added and mixed into at least one of a coating material, a welding powder, a welding powder additive, and a flux additive so as to obtain a titanium-containing material mixture. The titanium-containing material mixture is processed so as to provide the at least one of the coating material, the welding powder, the welding powder additive, and the flux additive.

### DETAILED DESCRIPTION

The process of the present invention for producing a coating material for coating welding electrodes or for producing a welding powder which can be used in electric welding, in particular under-powder welding, welding powder additive or flux additive, is characterized in that a titanium-containing, in particular titanium dioxide-containing, material obtained as a by-product or a waste product in a production step or in a production stage during the course of a titanium dioxide production process, in particular titanium dioxide pigment production process, is added and/or mixed into the coating material or the welding powder and/or the welding powder additive and/or the flux additive and processed, for example, processed further, to give the coating material or the welding powder and/or the welding powder additive and/or the flux additive.

The process of the present invention for utilizing a titanium-containing by-product or waste product obtained in the preparation of titanium dioxide is characterized in that the titanium-containing by-product or waste product is used as a coating material for coating welding electrodes or as an additive in a welding process, in particular, an under-powder welding process.

The use of a titanium-containing by-product obtained in the preparation of titanium dioxide is characterized in that the titanium-containing by-product is used as a coating material for welding electrodes or as an additive in a welding process, in particular, in an under-powder welding process, and/or as titanium oxide-containing, in particular, titanium dioxide-containing, material in the production of welding powder and/or welding powder additive and/or flux additive.

The use of a titanium-containing by-product of waste product obtained in the preparation of titanium dioxide for coating welding electrodes or in a welding process, in particular, an under-powder welding process, or for producing welding powder or a welding powder additive or flux additive makes it possible to utilize this titanium-containing by-product or waste product economically. The titanium-containing by-product or waste product can be used as an additive for the welding powder required in the welding process, as an additive for the flux or else as an additive for coating welding electrodes. The titanium-containing by-product or waste product has a high constancy in its composition, so that it can be used particularly well as a coating material for a welding electrode or as an additive to a welding process or as an additive for a welding powder. The type of accompanying elements occurring in addition to titanium dioxide (TiO₂), in particular silicon (Si) and aluminum (Al), is very compatible with the requirements in welding.

In an embodiment of the present invention, the titanium-containing by-product or waste product contains titanium dioxide. The presence of titanium dioxide in the titanium-containing by-product or waste product makes it possible to achieve particularly good mechanical properties, in particular, a high toughness at low temperatures, in particular in the case of the material to be welded by means of electric welding. From the titanium dioxide, metallic titanium can pass into the material being welded via, for example, the electric arc provided in under-powder welding, as a result of which, firstly, the good mechanical properties of the material being welded and, secondly, easy removal of the initial slag during welding in a narrow welding join can be brought about. A very smooth welding bead surface having very few defects can be achieved in this way.

In an embodiment of the present invention, the titanium-containing by-product or waste product can, for example, have a titanium dioxide content of 10-70% by weight, for example, 20-60% by weight. The titanium dioxide content of the titanium-containing by-product or waste product for use as coating material or as welding powder additive for a welding powder according to the present invention can, for example, be above 10% by weight, in particular, above 20% by weight, since lower titanium dioxide contents can have an adverse effect on the shape and surface of the welding bead, for example, in the form of a reduced toughness of the welding joint or in that the slag on the welding bead surface can be removed only with difficulty.

In an embodiment of the present invention, the titanium-containing by-product or waste product can, for example, have a sulfur content of <2.0% by weight, for example, <1.0% by weight, for example, <0.5% by weight, for example, <0.2% by weight, for example, <0.05% by weight. A very low sulfur content in the titanium-containing by-product or waste product enables the properties of the titanium-containing by-product or waste product as coating material or as welding powder additive to be improved. The sulfur content can be reduced by chemical or thermal treatment, for example, by calcination.

In an embodiment of the present invention, the titanium-containing by-product or waste product can, for example, have a silicon dioxide content (SiO₂ content) of 0.1-40% by weight, for example, 5-30% by weight, for example, 10-25% by weight. Silicon dioxide serves as an acidic constituent for adjusting the viscosity and gives a glassy slag giving a good appearance of the bead surface.

In an embodiment of the present invention, the titanium-containing by-product or waste product can, for example, have a chloride content of <0.3% by weight, for example, <0.1% by weight, for example, <0.02% by weight.

In an embodiment of the present invention, the titanium-containing by-product or waste product can, for example, have a magnesium content of 0.1-30% by weight, for example, 2.0-20% by weight, for example, 3.0-8.0% by weight. The magnesium can, for example, be present as magnesium oxide or in the form of oxidic compounds.

In an embodiment of the present invention, the titanium-containing by-product or waste product can, for example, have a BET surface area of 1-30 m²/g, for example, 1-20 m²/g, for example, 1-15 m²/g.

In an embodiment of the present invention, the titanium-containing by-product or waste product can, for example, contain iron titanium oxides and/or titanite (CaTiO(SiO₄)) and/or aluminum titanium silicate.

In an embodiment of the present invention, a titanium-containing by-product or waste product obtained as a digestion residue in the preparation of titanium dioxide by the sulfate process is used. The titanium-containing by-product or waste product can, for example, also be present in the form of rutilite. The properties of and production process for rutilite are described in DE 103 36 650 A1. The digestion residue is formed in the preparation of titanium dioxide by the sulfate process in which a digestion solution is produced by digestion of ilmenite, a titanium-iron ore (TiFeO₃) or titanium slag with highly concentrated sulfuric acid, and a solids-containing mass is obtained from the resulting digestion solution by solids being separated off, in particular by filtration. The digestion residue generally contains from about 30 to 70% by weight of titanium dioxide accompanied by magnesium and/or aluminum and/or iron and/or calcium (mainly in the form of titanates). For example, at least 50% by weight, or, for example, at least 90% by weight, of the titanium dioxide in the digestion residue can be in the rutile form. These values are based purely on the total amount of rutile and anatase, with other crystal modifications and X-ray amorphous constituents not being taken into account. The digestion residue can, for example, contain both magnesium titanate, e.g. in the form of MgTi₂O₅ and/or Mg_{0.75}Ti_{2.25}O₅, as iron titanate, e.g. ilmenite (FeTiO₃), also as calcium titanate, e.g. CaTiO₄. The digestion residue can furthermore, for example, contain iron oxides or iron titanium oxides in an amount of, for example, 0.5-30% by weight, for example, in an amount of 2-15% by weight, calculated as Fe₂O₃. The digestion residue can furthermore, for example, have an aluminum content, for example, as Al₂O₃, of 0.5-20% by weight, for example, 1-10% by weight, and a silicon content, for example, as SiO₂, of 5-40% by weight, for example, 15-35 by weight. The digestion residue can, for example, be obtained in the form of a filter cake, as a result of which a generally finely divided solid is obtained. It can also, for example, be obtained by adding a base as a neutralizing agent to the filter cake until a pH of from 5 to 12 has been attained. Washing of the sulfate from the digestion residue gives a low-sulfate, neutralized, finely divided material. Washing of the filter cake initially obtained can be carried out by means of filtration apparatuses known per se, e.g. a rotary vacuum filter or a chamber or membrane filter press. The washed digestion residue obtained in this way contains a small amount of sulfates. It is also possible to carry out the neutralization of the filter cake without prior slurrying directly in or on the filtration apparatus by washing the filter cake with an aqueous solution of the neutralizing agent. Suitable neutralizing agents are all customary alkaline compounds, e.g. solid or dissolved alkali metal hydroxides or alkaline earth metal hydroxides. Ammonium compounds can be particularly advantageous as neutralizing agent because anions such as sulfates or chlorides can in this way be removed partially or completely by subsequent calcination. The titanium concentrate obtained in this way can, for example, be dried. Drying can be carried out using any method and apparatus known to those skilled in the art, for example, in a drying oven, by means of a belt dryer, spray dryer or a spin-flash dryer. However, it can also be advantageous not to dry the filter cake but instead firstly mix further additives which are advantageous for the welding powder or the welding powder additive, for example, Ca- and Al-containing compounds, metal powders, lime or fluorides, e.g. CaF₂, into it, optionally with the assistance of further addition of water. At least 90% of the particles of the digestion residue can, for example, have a diameter of less than 90 μm. A digestion residue is, for example, the filler described in DE 197 25 021 A1.

In an embodiment of the present invention, a titanium-containing by-product or waste product obtained in the preparation of titanium dioxide by the chloride process after the chlorination processes is used, where the chlorination process is a step or stage of the chloride process. In the chloride process, enriched titanium ore or rutile together with coke are reacted with chlorine gas and the oxygen-containing gases from TiCl₄ combustion at about 1000° C. in a particularly chlorine-resistant fluidized-bed furnace. Here, the chlorine reacts with the titanium oxide of the ore and the introduced carbon to form gaseous titanium tetrachloride and carbon dioxide. The main components of the reactor bed are the titanium-containing raw material, coke (petroleum coke) and SiO₂ which accumulates increasingly in the reactor bed over time, so that part of the reactor bed has to be removed from the reactor at regular intervals. Residues in the form of titanium-containing by-products are obtained during the chlorination process and these can, owing to their composition, be used particularly well according to the present invention as an additive for a coating material for coating a welding electrode or as a welding powder or a welding powder additive. The finely divided solids discharged from the chlorination furnace (mainly TiO₂, SiO₂ and coke) can, after removal of TiCl₄ and the other metal chlorides, also be passed to use as an additive in welding. Washing for removing the soluble metal chlorides can, for example, be carried out. Furthermore, the, in particular hydroxidic, neutralization products of the metal chlorides obtained in the chloride process can be passed to use as additive in welding since these can still contain appreciable amounts of titanium (Ti) as impurity. A thermal treatment can, for example, be carried out in order to convert the hydroxides into oxides.

To improve the properties of the titanium-containing by-product or waste product, the titanium-containing by-product or waste product obtained in the sulfate process or in the chlorination process can, for example, be at least partly freed of soluble anions, mainly sulfate and chloride, by washing. As an alternative to washing, the soluble anions obtained in the sulfate process or those obtained in the chlorination process can be neutralized in the titanium-containing by-product or waste product by means of ammonia, and the resulting ammonium salts can be driven off thermally.

It is possible to carry out the neutralization to a pH in a range from 6 to 8 and subsequently wash out the neutral salts. However, certain amounts of sulfate or chloride frequently remain in the solid in this case. As an alternative, neutralization using alkaline compounds can be carried out to a pH of >8, for example, >10. The residual content of sulfate or chloride can in this way be brought to very low values. Use can, for example, be made of alkaline materials which are themselves also used as additive for welding powder. Examples are MgO, MgCO₃, Mg(OH₂), sodium silicate (Na₂SiO₃) and similar compounds which have an alkaline reaction and do not form any sparingly soluble sulfates or chlorides.

In an embodiment of the present invention, the washing-out of the soluble anions can, for example, be carried out after a filtration process carried out by washing with an alkaline solution. As an alkaline solution, use can, for example, be made of magnesium compounds such as MgO, Mg(OH)₂ or MgCO₃. As an alternative, it is also possible to use sodium silicate as an alkaline solution.

Before use as a coating material for welding electrodes or as an additive in a welding process or before or during the production of welding powder or welding powder additive or flux additive, the titanium-containing by-product or waste product can, for example, be calcined.

If no calcination of the titanium-containing by-product or waste product is carried out before use as coating material for welding electrodes or as additive in a welding process or before or during production of welding powder or welding powder additive or flux additive, it is alternatively possible to mix the titanium-containing by-product or waste product with mineral additives before use as a coating material for welding electrodes or as an additive in a welding process or before or during production of welding powder or welding power additive or flux additive.

In an embodiment of the present invention, the titanium-containing by-product or waste product can, for example, be mixed with an ilmenite, a titanium slag and/or an iron-containing dissociation product, for example, before use as a coating material for welding electrodes or as an additive in a welding process or before or during production of welding powder or welding powder additive or flux additive. This makes it possible to increase the iron content of the titanium-containing by-product or waste product. This is particularly advantageous when the titanium-containing by-product or waste product is used for producing the welding powder or welding powder additive to be used for the welding process.

The present invention further provides a welding powder additive which has been produced from a titanium-containing by-product or waste product by a process as described above. The titanium-containing by-product or waste product present in the welding powder additive contains, for example, iron titanium oxides and/or titanite (CaTiO(SiO₄)) and/or aluminum silicate and can, for example, be a digestion residue from the preparation of titanium dioxide by the sulfate process or a residue obtained in a process step of chlorination in a chloride process in the preparation of titanium dioxide.

In an embodiment of the present invention, the titanium-containing by-product or waste product can, for example, be present in a proportion by mass of 5-100% by weight, for example, 10-60% by weight, for example, 10-30% by weight, in the welding powder additive.

In an embodiment of the present invention, 1-30% by weight, for example, 5-15% by weight, of titanium oxide hydrate can be present in the welding powder additive.

The present invention further provides a welding powder comprising a welding powder additive as described above.

The present invention further provides a coating material for welding electrodes, which has been produced from a titanium-containing by-product or waste product by a process as described above. The titanium-containing by-product or waste product present in the coating material can, for example, contain iron titanium oxides and/or titanite (CaTiO(SiO₄) and/or aluminum silicate and can, for example, be a digestion residue from the preparation of titanium dioxide by the sulfate process or a residue obtained in a process step of chlorination in a chloride process in the preparation of titanium dioxide.

In an embodiment of the present invention, the titanium-containing by-product or waste product can, for example, be present in a proportion by mass of 5-100% by weight, for example, 10-60% by weight, for example, 10-30% by weight, in the coating material.

In an embodiment of the present invention, 1-30% by weight, for example, 5-15% by weight, of titanium oxide hydrate can be present in the coating material.

The present invention is illustrated below with the aid of four examples:

### EXAMPLES

### Example 1

A digestion residue from titanium dioxide production by the sulfate process was first separated off from the black solution by filtration. The filter cake obtained in this way was subsequently resuspended and neutralized by means of sodium hydroxide (pH =6 to 9) and filtered again by means of a filter press and intensively washed so that a sulfate content of <0.5% by weight, based on solids, was obtained. The material obtained in this way was subsequently suspended and the suspension obtained was spray dried. The BET surface area of the material was 10.6 m²/g. The pretreated digestion residue obtained in this way and containing

48.2% by weight of TiO₂

26.3% by weight of SiO₂

7.7% by weight of Fe₂O₃

3.2% by weight of Al₂O₃

2.3% by weight of MgO

3.6% by weight of CaO

was mixed with conventional CaO-, Al₂O₃-, SiO₂- and CaF₂-containing materials so as to obtain a weight ratio of TiO₂:CaO:Al₂O₃:SiO₂:CaF₂ of 23:16:11:32:11. The mixture obtained in this way provided a welding powder having a low viscosity, good wetting behavior and good stability of the electric arc. Further additives such as alkali metal compounds or metals can be added to the welding powder, depending on the specific properties desired.

### Example 2

A solids mixture which was obtained in the process step of continuous chlorination of titanium-containing starting materials in the preparation of titanium dioxide by the chloride process and was taken off from the bed of the reactor was neutralized by means of sodium hydroxide (pH=8 to 10) and filtered by means of a filter press, intensively washed and subsequently dried. To eliminate the carbon content, the material obtained was subjected to a calcination step. This provided a material which comprised

26% by weight of TiO₂

54% by weight of SiO₂

4% by weight of Fe₂O₃

6% by weight of MgO

and this material was mixed with conventional CaO-, Al₂O₃-, SiO₂- and CaF₂-containing materials so as to obtain a weight ratio of TiO₂:CaO:Al₂O₃:SiO₂:CaF₂ of 23:16:11:32:11. The mixture obtained in this way provided a welding powder having a low viscosity, good wetting behavior and good stability of the electric arc. Further additives such as alkali metal compounds or metals can be added to the welding powder, depending on the specific properties desired.

### Example 3

A thermally treated digestion residue as described in Example 1 of DE 103 36 350 A1 and comprising

53% by weight of TiO₂

28% by weight of SiO₂

5.9% by weight of Fe₂O₃

6.1% by weight of Al₂O₃

2.4% by weight of MgO

4.2% by weight of CaO

was mixed with conventional CaO-, Al₂O₃-, SiO₂- and CaF₂-containing materials so as to obtain a weight ratio of TiO₂:CaO:Al₂O₃:SiO₂:CaF₂ of 23:16:11:32:11. The mixture obtained in this way provided a welding powder having a low viscosity, good wetting behavior and good stability of the electric arc. Further additives such as alkali metal compounds or metals can be added to the welding powder, depending on the specific properties desired.

### Example 4

A digestion residue from titanium dioxide production by the sulfate process was firstly separated off from the black solution by filtration, the resulting filter cake was then resuspended and neutralized by means of sodium hydroxide (pH=6 to 9) and filtered again by means of a filter press and intensively washed so as to give a sulfate content of 0.7% by weight, based on solids. The material obtained in this way was dried in a drying oven and the pretreated digestion residue which was then obtained and comprising

59% by weight of TiO₂

20% by weight of SiO₂

13% by weight of Fe₂O₃

was mixed with conventional materials for producing rutile welding electrodes, i.e. CaCO₃, SiO₂, Fe₃O₄, TiO₂ (natural rutile) and Fe-Mn powder so as to give the following composition

45% by weight of TiO₂

20% by weight of SiO₂

10% by weight of Fe₃O₄

10% by weight of CaCO₃

15% by weight of Fe-Mn powder

where the proportion of digestion residue was 25% by weight, based on the total amount. Sodium silicate was used as binder. The mixture obtained in this way provided a welding powder having good welding behavior and good stability of the electric arc.

The present invention is not limited to embodiments described herein; reference should be had to the appended claims.

What is claimed is:

1-25. (canceled)

26. A process for producing a coating material for at least one of coating welding electrodes and for producing a welding powder which can be used in at least one of an electric welding, such as in an under-powder welding, a welding powder additive, and a flux additive, the process comprising:
obtaining a titanium-containing by-product or waste product, such as a titanium dioxide-containing material, in at least one of a production step and a production stage during a titanium dioxide production process, such as a titanium dioxide pigment production process;
at least one of adding and mixing the titanium-containing by-product or waste product into at least one of a coating material, a welding powder, a welding powder additive, and a flux additive so as to obtain a titanium-containing material mixture; and
processing the titanium-containing material mixture so as to provide the at least one of the coating material, the welding powder, the welding powder additive, and the flux additive.

27. The process as recited in claim 26, wherein the titanium-containing by-product or waste product comprises titanium dioxide.

28. The process as recited in claim 27, wherein the titanium-containing by-product or waste product has a titanium dioxide content of 10-70 wt. %.

29. The process as recited in claim 26, wherein the titanium-containing by-product or waste product has at least one of a sulfur content of <2.0 wt.-%, a silicon dioxide content of 0.1-40 wt.-%, a chloride content of <0.3 wt.-%, a magnesium content of 0.1-30 wt.-%, and a BET surface area of 1-30 m²/g.

30. The process as recited in claim 26, wherein the titanium-containing by-product or waste product comprises at least one of an iron titanium oxide, a titanite (CaTiO(SiO₄)) and an aluminum titanium silicate.

31. The process as recited in claim 26, wherein the titanium-containing by-product or waste product is obtained as a digestion residue in the preparation of titanium dioxide by a sulfate process or after a chlorination process in the preparation of titanium dioxide by a chloride process.

32. The process as recited in claim 31, further comprising washing the titanium-containing by-product or waste product obtained in the sulfate process or in the chloride process so as to at least partially free the titanium-containing by-product or waste product from soluble anions.

33. The process as recited in claim 26, further comprising calcining the titanium-containing by-product or waste product.

34. The process as recited in claim 26, further comprising mixing the titanium-containing by-product or waste product with mineral additives.

35. The process as recited in claim 26, further comprising mixing the titanium-containing by-product or waste product with at least one of an ilmenite, a titanium slag and an iron-containing dissociation product.

36. A process of using a titanium-containing by-product or waste product obtained in the preparation of titanium dioxide, the process comprising:
providing the titanium-containing by-product or waste product; and
using the titanium-containing by-product or waste product as a coating material for coating welding electrodes or as an additive in a welding process, such as in an under-powder welding process.

37. The process as recited in claim 36, wherein the titanium-containing by-product or waste product comprises titanium dioxide.

38. The process as recited in claim 37, wherein the titanium-containing by-product or waste product has a titanium dioxide content of 10-70 wt.-%.

39. The process as recited in claim 36, wherein the titanium-containing by-product or waste product has at least one of a sulfur content of <2.0 wt.-%, a silicon dioxide content of 0.1-40 wt.-%, a chloride content of <0.3 wt.-%, a magnesium content of 0.1-30 wt.-%, and a BET surface area of 1-30 m²/g.

40. The process as recited in claim 36, wherein the titanium-containing by-product or waste product comprises at least one of an iron titanium oxide, a titanite (CaTiO(SiO₄)) and an aluminum titanium silicate.

41. The process as recited in claim 36, wherein the titanium-containing by-product or waste product is obtained as a digestion residue in the preparation of titanium dioxide by a sulfate process or after a chlorination process in the preparation of titanium dioxide by a chloride process.

42. The process as recited in claim 41, further comprising washing the titanium-containing by-product or waste product obtained in the sulfate process or in the chloride process so as to at least partially free the titanium-containing by-product or waste product from soluble anions.

43. The process as recited in claim 36, further comprising calcining the titanium-containing by-product or waste product.

44. The process as recited in claim 36, further comprising mixing the titanium-containing by-product or waste product with mineral additives.

45. The process as recited in claim 36, further comprising mixing the titanium-containing by-product or waste product with at least one of an ilmenite, a titanium slag and an iron-containing dissociation product.

46. A process of using a titanium-containing by-product or waste product obtained in the preparation of a titanium dioxide, the process comprising:
providing the titanium-containing by-product or waste product obtained in the preparation of the titanium dioxide; and
using the titanium-containing by-product or waste product as at least one of:
a coating material for welding electrodes,
as an additive in a welding process, such as in an under-powder welding process, and
as a titanium oxide-containing material in the production of at least one of a welding powder, a welding powder additive and a flux additive.

47. A welding powder additive produced by the process recited in claim 26, wherein the titanium-containing by-product or waste product is present in a proportion by mass of 5-100 wt.-%.

48. The welding powder additive as recited in claim 47, wherein the welding powder additive comprises 1-30 wt.-% of titanium oxide hydrate.

49. A welding powder comprising the welding powder additive as recited in claim 47.

50. A coating material produced by the process recited in claim 26, wherein the titanium-containing by-product or waste product is present in a proportion by mass of 5-100 wt.-%.

51. The coating material as recited in claim 50, wherein the coating material comprises 1-30 wt.-% of titanium oxide hydrate.

52. A welding electrode comprising a metallic core and a coating, wherein the coating is formed by the coating material as recited in claim 50.
